(19) United States
(12) Patent Application Publication
(10) Pub. No.: US 2008/0055481 A1
(43) Pub. Date: Mar. 6, 2008

(54) Method and System for Efficiently Increasing the Temporal Depth of a 3D Comb Filter

(76) Inventors: Brad A. Delanghe, Sunnyvale, CA (US); Aleksandr M. Movshovich, Santa Clara, CA (US)

Correspondence Address: MCANDREWS HELD & MALLOY, LTD, 500 WEST MADISON STREET, SUITE 3400, CHICAGO, IL, 60661, US

(21) Appl. No.: 11/468,864

(22) Filed: Aug. 31, 2006

(51) Int. Cl. H04N 9/78

(52) U.S. Cl. 348/667

(57) ABSTRACT

Processing signals in a video system may include detecting motion in at least one of a plurality of video frames, storing the results of the detecting to a buffer and comb filtering at least one future frame using the results stored in the buffer. Detecting the difference may include computing the difference between at least two of the plurality of frames on a pixel by pixel basis and comparing the difference to a threshold. The width and height of the buffer may be the same as the width and height of a video frame and a result may be stored in a location in the buffer corresponding to the location in the video frame where motion may have been detected. The buffer may hold the data representing motion from a plurality of frames. The processing may further include extracting chroma and luma information from a composite video signal by using a frame comb filter.

### CROSS-REFERENCE TO RELATED APPLICATIONS/INCORPORATION BY REFERENCE

Not Applicable.

### FIELD OF THE INVENTION

Certain embodiments of the invention relate to processing signals. More specifically, certain embodiments of the invention relate to a method and system for efficiently increasing the temporal depth of a 3D comb filter.

### BACKGROUND OF THE INVENTION

A composite video signal is the sum of a luminance (brightness) signal and a chrominance (color) signal. These signals may be referred to as luma and chroma signals, respectively. The frequency ranges of the luma and chroma signals may be designed to overlap. The luma signal may extend from DC to 4.2 MHz and the chroma signal may be centered at 3.58 Mhz with a bandwidth of 1.8 MHz. In video processing, the luma and chroma signal components may be added together in order to generate a composite video signal. The luma and chroma video elements may be integrated and broadcasted as a single composite video stream. Once the broadcasted composite signal is received, the luma and chroma signal components must be separated in order for the video signal to be processed and displayed. A comb filter may be utilized for separating the chroma and luma video signal components. For example, a television may be adapted to receive a composite video input and utilize an integrated comb filter to separate the chroma and luma video signal components. However, before the television may display the received video signal, the chroma and luma video components may have to be separated.

In conventional video processing, there may be several ways to separate the luma and chroma video components. These may include combing horizontally, combing vertically, and combing temporally. Each of these combing methods may have certain disadvantages. For example, in horizontal combing a notch filter at 3.58 MHz may be used to separate the chroma from the luma. This, however, may result in a loss of luma information around the notch frequency.

In vertical combing, a given line of video may be added and/or subtracted form the video line above and below the given line, yielding a luma and chroma signal. This may work because the chroma signal alternates by 180 degrees from one line to the next and two adjacent lines may contain almost identical information. Although better than horizontal combing, artifacts may be produced when adjacent lines are, for example, different from one another.

In temporal combing two frames of video may be compared. In temporal combing an assumption may be made that the video information between adjacent frames has not changed. Also, the chroma phase on any given line may be 180 degrees out of phase with the corresponding line on an adjacent frame. Given these two assumptions, the difference between adjacent frames may yield a luma and chroma signal, free from the artifacts of a horizontal coming system and a vertical coming system. However, performing temporal combing where the information between adjacent frames has changed may become challenging.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for efficiently increasing the temporal depth of a 3D comb filter, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a diagram illustrating the generation of a conventional composite video signal, in connection with an embodiment of the invention.

FIG. 1B is a diagram illustrating the position of color burst and active video in a conventional composite video signal, in connection with an embodiment of the invention.

FIG. 1C is a graphical diagram illustrating the phase relationship of modulated chroma signals in contiguous composite video signal frames, in connection with an embodiment of the invention.

FIG. 2 is a block diagram of an exemplary system for comb filtering a composited video signal, in accordance with an embodiment of the invention.

FIG. 3A is a diagram illustrating 2D and 3D bidirectional comb filtering, in accordance with an embodiment of the invention.

FIG. 3B is a diagram of a blending decision factor related to blending to a previous line versus blending to a next line, in accordance with an embodiment of the invention.

FIG. 3C is a diagram of a blending decision factor related to blending vertically versus blending horizontally, in accordance with an embodiment of the invention.

FIG. 3D is a diagram of a blending decision factor related to enabling horizontal combing versus disabling horizontal combing, in accordance with an embodiment of the invention.

FIG. 3E is a diagram of a blending decision factor related to horizontal combing, in accordance with an embodiment of the invention.

FIG. 4A is a diagram of coarse luma determination, in accordance with an embodiment of the invention.

FIG. 4B is a diagram of a 3D comb filter mesh mask, in accordance with an embodiment of the invention.

FIG. 4C is another diagram of a 3D comb filter mesh mask, in accordance with an embodiment of the invention.

FIG. 4D is a diagram of a 3D comb filter mesh mask for bidirectional comb, in accordance with an embodiment of the invention.

FIG. 4E is a diagram of a 3D comb filter mesh, in accordance with an embodiment of the invention.

FIG. 5A is a figure representing motion between a top frame and bottom frame, in accordance with an embodiment of the invention

FIG. 5B is a figure of an exemplary quantized motion frame buffer (QMFB) in accordance with an embodiment of the invention.

FIG. 6 is a flow diagram of an exemplary motion estimator for 3D bidirectional combing, in accordance with an embodiment of the invention.

FIG. 7 is a flow diagram of exemplary steps utilizing past motion estimates in a 3D bidirectional combing system, in accordance with an embodiment of the invention.

FIG. 8 is a flow diagram of an exemplary method for bidirectional comb filtering of a composite video signal, in accordance with an embodiment of the invention.

### DETAILED DESCRIPTION OF THE INVENTION

Certain embodiments of the invention may be found in method and system for efficiently increasing the temporal depth of a 3D comb filter. Exemplary aspects of the invention may comprise detecting motion in at least one of a plurality of video frames, storing the results of the detecting to a buffer and comb filtering at least one future frame using the results stored in the buffer. Detecting the difference may include computing the difference between at least two of the plurality of frames on a pixel by pixel basis and comparing the difference to a threshold. The width and height of the buffer may be the same as the width and height of a video frame and a result may be stored in a location in the buffer corresponding to the location in the video frame where motion may have been detected. The buffer may hold the data representing motion from a plurality of frames. The processing may further include extracting chroma and luma information from a composite video signal by using a frame comb filter.

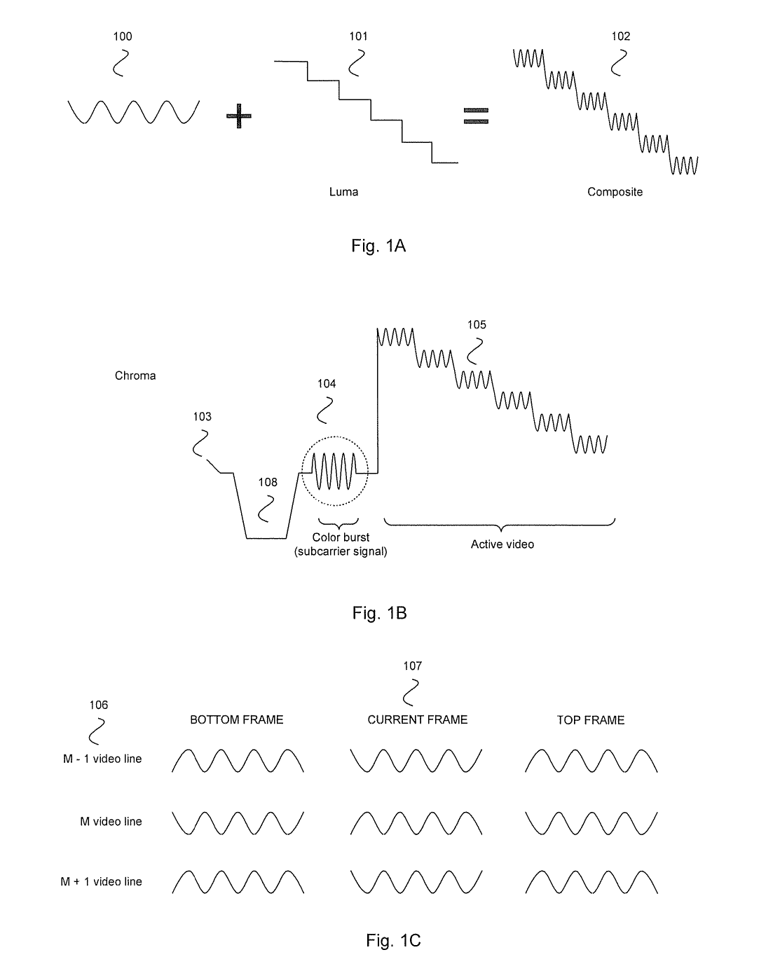

FIG. 1A is a diagram illustrating the generation of a conventional composite video signal, in connection with an embodiment of the invention. Referring to FIG. 1A, there is shown a chroma signal 100, a luma signal 101 and a signal representing the combination of the two 102. The luma signal component 101 may or may not increase in amplitude in a stair step fashion. The chroma signal component 100 may comprise a color difference component U that may, for example, be modulated by a sine signal with a 3.58 MHz frequency, and a color difference component V that may, for example, be modulated by a cosine signal with a 3.58 MHz frequency. The modulation scheme may be selected so that it provides quadrature modulation between the U and V color difference components. An exemplary composite video signal 102 may be a composite video signal with burst and syncs (CVBS).

FIG. 1B is a diagram illustrating the position of color burst and active video in a conventional composite video signal, in connection with an embodiment of the invention. Referring to FIG. 1B, there is shown a color burst 104, an active video signal portion 105, and a synchronization pulse 105. The color burst 104 may comprise a brief sample of, for example, eight to ten cycles of unmodulated color subcarrier which have been inserted by an NTSC or PAL encoder onto the back porch of the composite video signal to enable a decoder to regenerate the color subcarrier from it. The active video portion 105 of the composite video signal 103 may comprise luma and chroma signal components of the picture or image. The synchronization pulse 108 may be used to extract horizontal and vertical timing information, which may be used to determine correct placement of the active video signal 105 on a display.

FIG. 1C is a graphical diagram illustrating the phase relationship of modulated chroma signals in contiguous composite video signal frames, in connection with an embodiment of the invention. Referring to FIG. 1C, there is shown a bottom, current, and top frame 107 and video lines M−1, M and M+1 106. The chroma signal component in the active video portion of an NTSC composite video signal may be modulated at such a frequency that every line of video in a video frame may be phase-shifted by 180 degrees from the previous line. The bottom frame, the current frame, and the top frame may be contiguous composite video frames and the (M−1) video line, the M video line, and the (M+1) video lines may be contiguous video lines within the video frame, where M corresponds to any current line which may have a previous line and a next line adjacent to it. The “bottom frame” may correspond to the frame that is currently being received while the “current frame” and the “top frame” may correspond to frames that have been delayed by one and two frames respectively. The M video line in the “current frame” may be phase-shifted by 180 degrees from the (M−1) video line in the “current frame” as well as from the (M+1) video line in the “current frame.” Similarly, the M video line in the “bottom frame” may be phase-shifted by 180 degrees from the (M−1) video line in the “bottom frame” as well as from the (M+1) video line in the “bottom frame.” In addition, since the fields may be at a frequency rate of 59.94 Hz, there may be a 180-degree phase shift between two adjacent frames, for example, the “current frame” and the “top frame.” Correspondingly, the M video line in the “current frame” may be 180 degrees phase-shifted from the M video line in the “top frame.”

In a PAL composite video signal, adjacent video lines and adjacent frames may have a 90-degree phase shift, requiring a two line or two frame delay in order to obtain video lines or frames with a 180-degree phase shift.

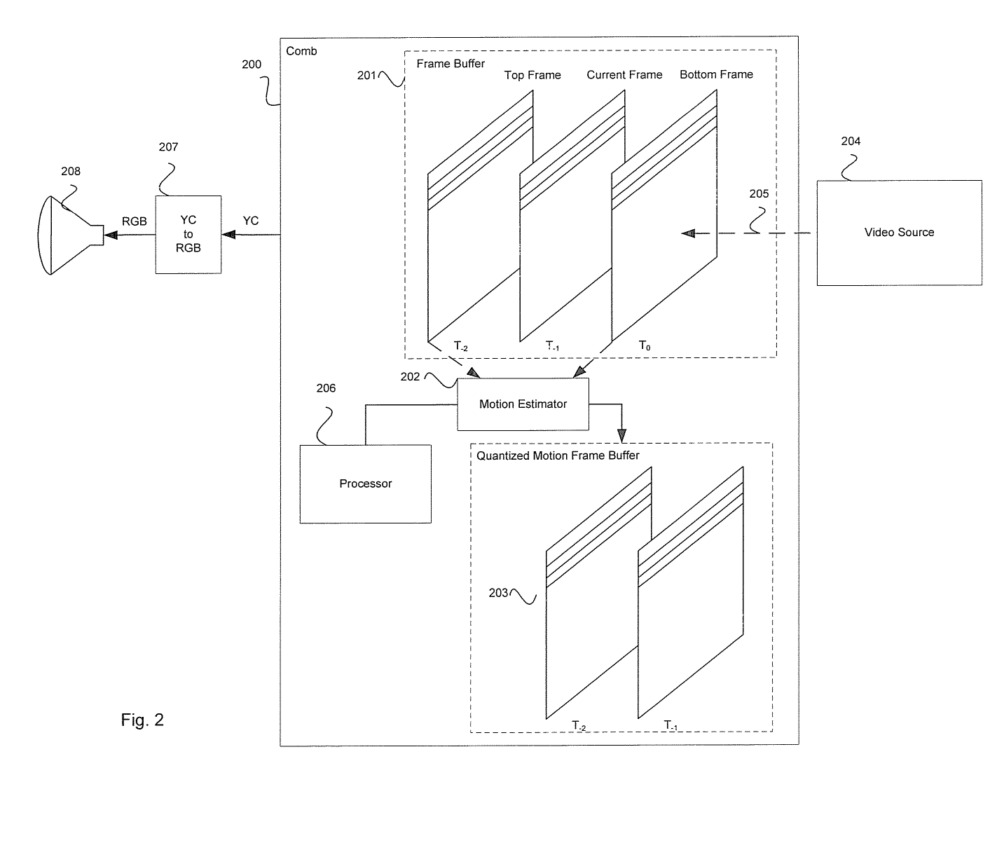

FIG. 2 is a block diagram of an exemplary system for comb filtering a composite video signal, in accordance with an embodiment of the invention. Referring to FIG. 2, there is shown a video source 204, a comb filter 200, a YC to RGB converter 207, and a display 208. The video source 204 may comprise suitable logic, circuitry and/or code for the generation of a composite video signal. For example, the video source 204 may be a conventional NTSC tuner or a video tape recorder. The video signal 205 may be a conventional composite video signal as shown in FIG. 1A, FIG. 1B and FIG. 1C. The video signal 205 from the video source 204 may enter a comb filter 200.

The comb filter 200 may comprise suitable logic, circuitry and/or code for reception of a video signal 205 from the video source 204 and for separation of the chroma and luma components from the video signal 205. The YC to RGB converter 207 may comprise suitable logic, circuitry and/or code for conversion of the chroma and luma components from the comb filter 200 into red, green and blue components. The red, green and blue components may subsequently be used to drive the display 208.

Referring to the comb filter 200, shown is a frame buffer 201, a motion estimator 202, a quantized motion frame buffer 203, and a processor 206. The frame buffer 201 may comprise suitable logic, circuitry and/or code for conversion of the video signal 205 from the video source 204 into a form suitable for storage in a memory. For example, the frame buffer may sample the video signal 205 via an analog to digital converter. The analog to digital converter may sample at, for example, 4*Fsc, where Fsc may be the chroma subcarrier frequency 3.58 MHz. The frame buffer may use the synchronization portion 108 (FIG. 1B) of the video signal 205 to determine the location to store the sampled video information. For example, the frame buffer may determine that the current sample of the video signal 205 corresponds to the upper left corner of a display. In this case, the frame buffer may store this sample in an area of memory corresponding to the upper left corner of the display.

The frame buffer 201 may comprise enough memory to store several frames of the video signal 205. The frame buffer 201 may use the synchronization portion 108 of the video signal to determine where in memory to store the frame currently being sampled. For example, a first frame of video may be sampled and stored in an area of the frame buffer corresponding to a top frame, a second frame of video may be sampled and stored in an area of the frame buffer corresponding to a current frame, and a third frame of video may be sampled and stored in an area of the frame buffer corresponding to a bottom frame. In this regard, the bottom frame may contain the video information that may have been most recently sampled and the top frame may contain the video information that may have been sampled furthest in the past. The data in the frame buffer 201 may be used by the motion estimator 202 and the processor 206.

The motion estimator 202 may comprise suitable logic, circuitry, and/or code for detection of motion within the several frames of video stored in the frame buffer 201 and for storage of a motion estimate in the quantized motion frame buffer 203. In this regard, the motion estimator 202 may detect regions of motion in the video information by comparing the top frame and bottom frame in the frame buffer 202. The motion estimator 202 may then store data, representative of the detection process, to the quantized motion frame buffer (QMFB) 203. For example, if the motion estimator 202 detects motion in a particular region between the top and bottom frame in the frame buffer 201, the motion estimator 202 may store the motion estimates from the detecting step in a region of the QMFB 203, which may be used to determine whether motion occurred in that particular region. Information stored in the QMFB 203 may be used for comb filtering future frames.

The processor 206 may comprise suitable logic, circuitry and/or code for determining which of a plurality of methods to use in separating the chroma and luma components from the video input signal. For example, the processor may determine that there may not be any motion in a particular area of the video signal and may, for example, use a horizontal or a vertical combing procedure described below to separate the chroma and luma components. When motion is not detected, the processor may use, for example, a temporal combing procedure described below instead.

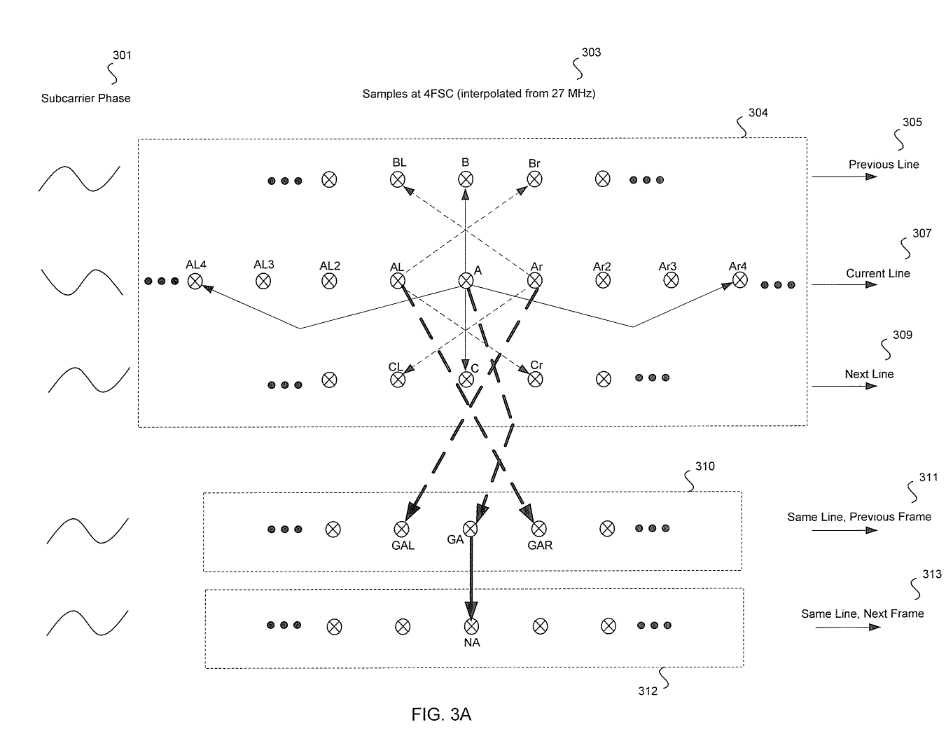

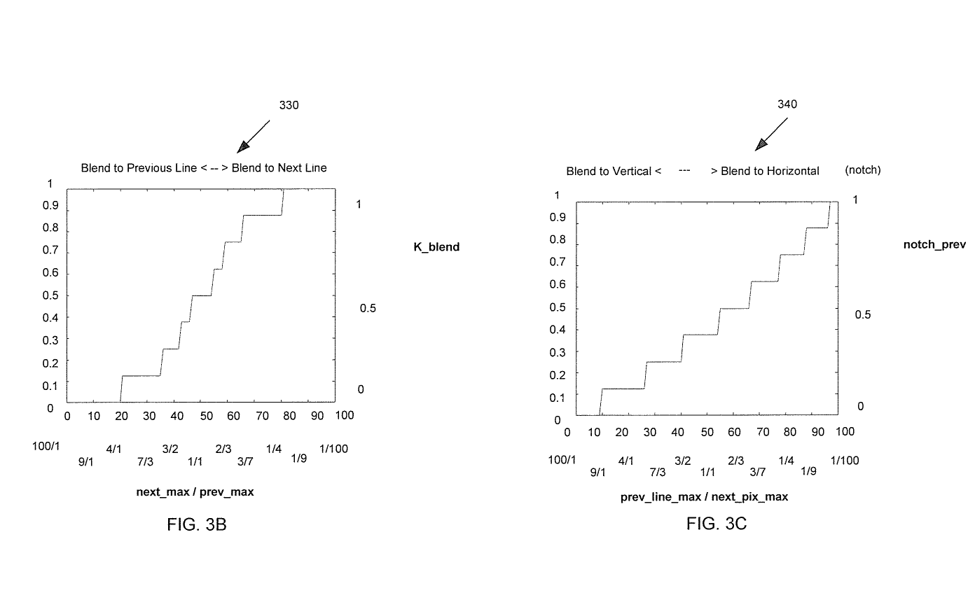

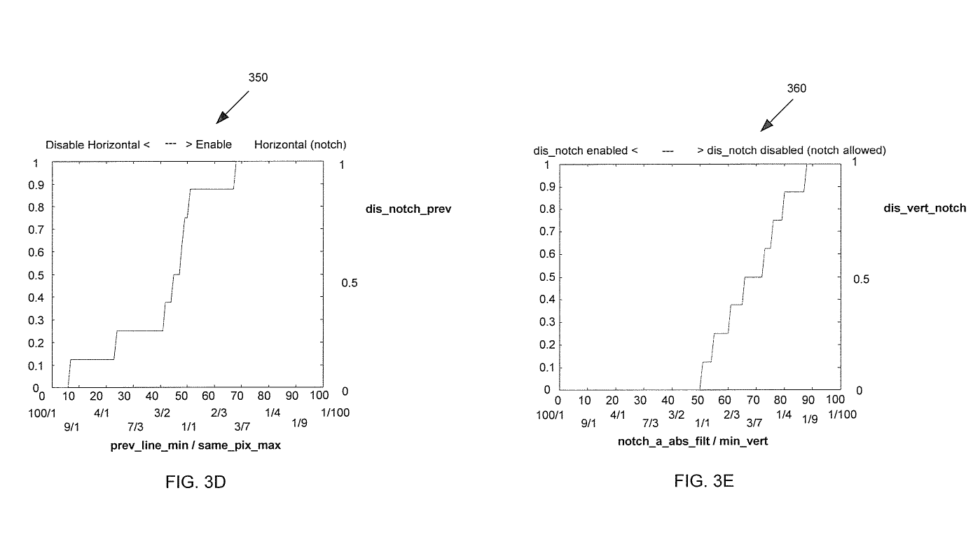

FIG. 3A is a diagram illustrating 2D and 3D bidirectional comb filtering, in accordance with an embodiment of the invention. Referring now to FIG. 3A, there is illustrated a sample of pixels from three adjacent lines in a current frame 304, a current line 307, a previous line 305, and a next line 309, as well as a same (current) line 311 in a previous frame 310 and a same (current) line 313 in a next frame 312. Pixels in the current line 307 may be one half cycle phase-shifted from corresponding pixels in the same line previous frame 311 and/or corresponding pixels in the same line next frame 313. In addition, pixels in the same line previous frame 311 may be in-phase with corresponding pixels in the same line next frame 312.

The subcarrier phase 301 of the incoming composite video signal may be 3.58 MHz, and the incoming analog video signal may be digitized at 27 MHz, for example. Since 3.58 MHz and 27 MHz are not multiples of each other, there may not be an exact pixel sample every 3.58 MHz of digitized video signal that may be aligned and in-phase. For example, it may be difficult to compare the peak of a sine wave on the current line 307 with the peak of a sine wave on the next line 309, since a pixel sample may not be obtained at the 27 MHz frequency. The composite video signal, therefore, may be run through a filter that interpolates pixel samples 303 at four times the frequency of the sub-carrier. For example, if the subcarrier frequency is at 3.58 MHz, the pixel samples 303 may be interpolated at 14.32 MHz.

Pixels A, B and C may be true pixels. However, all the remaining pixels to the left and to the right of the true sample pixels A, B and C, such as pixels BL, Br, AL, AL2, AL3, AL4, Ar; Ar2, Ar3, Ar4, CL, and Cr, may be interpolated pixels. In a given line, each pixel may be shifted by a quarter subcarrier cycle from the adjacent pixel. In addition, each line may be 180 degree phase-shifted from its adjacent line. For example, true pixel A and interpolated pixel AL4, to the left of true pixel A in the current line 307, may be in phase with each other, whereas true pixel A and interpolated pixel AL may be quarter cycle phase-shifted from each other. Similarly, interpolated pixel Ar may be a quarter cycle phase-shifted to the right of pixel A, and interpolated pixel Ar4 may be in phase with true pixel A. Since the current line 307 may be 180 degrees phase-shifted from either the previous line 305 or the next line 309, true pixel A may also be phase-shifted 180 degrees from either true pixel B in the previous line 305 or true pixel C in the next line 309.

In an embodiment of the present invention, the amount of frequency content movement may be approximated between pixels within a given pixel line, between pixel lines within the same video frame, and between similar pixel lines in different frames, and the corresponding combing method may be applied with a minimum bandwidth loss. For example, if vertical combing is applied with regard to true pixel A, then true pixel A may be subtracted from true pixel B resulting in two times the luma, or true pixel A may be subtracted from true pixel C to obtain two times the luma, or true pixel A may be subtracted from the average of true pixels B and C to obtain two times the luma. The same process may be performed between true pixel A and interpolated pixel AL2, since they may be out of phase. The phase difference between true pixels A and B may be 180 degrees, which may be the same as between true pixel A and interpolated pixel AL2. In order to determine whether vertical combing may be applied without a significant bandwidth loss, pixels in the current line 307 and the previous line 305 may be compared. For example, interpolated pixel AL in the current line 307 may be compared with interpolated pixel Br in the previous line 305, where interpolated pixel AL may be in phase with interpolated pixel Br since there may be a 360-degree phase difference between them. Similarly, interpolated pixel Ar may be compared with interpolated pixel BL, where interpolated pixel Ar may be in phase with interpolated pixel BL since there may be a 360 degree phase difference between them as well.

If these two comparisons indicate a big difference, this may be indicative of significant vertical frequency content going from true pixel B to true pixel A. If the difference between the interpolated pixels in the two comparisons is small, then this may indicate that there may not be a lot of vertical frequency content. Accordingly, vertical combing may be applied between the current line 307 and the previous line 305 without a significant bandwidth loss. Similarly, comparisons between the interpolated pixels AL and Cr, and Ar and CL may be indicative of whether vertical combing may be applied between the current line 307 and the next line 309, without a significant bandwidth loss. Depending on the composite video signal, there may be no frequency content between true pixel B and true pixel A, which indicates that the current line and the previous line may be identical lines. A large frequency content between true pixel A and true pixel C may indicate that a vertical transition has happened immediately after the current line. Conversely, there may be a lot of frequency content between true pixel B and true pixel A, and no frequency content between true pixel A and true pixel C. This may be characterized by the fact that the current line and the next line are very similar, but the current line and the previous line are different. In this case, vertical combing may be performed between the current line and the next line.

A final comparison may be performed between true pixels A, B and C, in order to determine whether vertical combing may be applied with a minimum bandwidth loss. If true pixels A, B and C are, for example, all in phase with each other, this may be indicative that there may not be a chroma component and that true pixels A, B and C contain only luma components. For example, if true pixels A, B and C contain only luma components, the video signal may comprise a white character or a black background. In this case, since there may be no frequency content between the current line 307, the previous line 305 and the next line 309, and vertical combing may be applied without a significant loss in bandwidth.

With regard to horizontal combing, or notch filtering, true pixel A may be compared with interpolated pixels AL4 and Ar4 in the current line 307, which may be in phase with true pixel A. This may provide an indication of the horizontal frequency content in the current line 307. If true pixel A is very different from either of interpolated pixels AL4 or Ar4, it may indicate that there may be significant frequency content in the current line 307. If, on the other hand, the pixels are very similar, it may indicate that there may be less frequency content and horizontal combing may be applied. In an embodiment of the present invention, a wide band pass filter may be utilized in order to horizontally filter a composite signal and eliminate the luma component that may not be near the chroma subcarrier frequency, for example, a 3.58 MHz subcarrier frequency.

In another aspect of the invention, bidirectional combing may be implemented by taking into consideration temporal signal comparisons between non-adjacent in-phase frames for purposes of applying temporal combing with a minimum temporal bandwidth loss. Referring again to FIG. 3A, pixels in the same line/previous frame 311 and same line/next frame 313 may be considered. For example, pixel GA may be a true pixel similar to true pixel A, but it may be phase-shifted 180 degrees from true pixel A in the previous frame 310. In addition, pixel NA may be a true pixel similar to true pixel A, but it may be phase-shifted 180 degrees from true pixel A in the next frame 312. Since true pixels GA and NA may be phase-shifted at 360 degrees and may be in phase with each other, they may be compared for temporal frequency content. More specifically, a coarse luma signal may be generated for both true pixel GA in the previous frame 310 and true pixel NA in the next frame 312. The difference between the coarse luma values for true pixels GA and NA may be indicative of the signal bandwidth between the previous frame 310 and the next frame 312 and whether the composite signal may be combed temporally and to what extent. The bandwidth measure between the true pixels GA and NA and the associated temporal combing quality may then be compared with the quality of 2D combing for the composite signal and whether horizontal and/or vertical combing may be applied within the current frame 304, and to what extent. Temporal combing as measured by the bidirectional combing process, as well as vertical and/or horizontal combing, may then be blended without a threshold and applied to the composite signal to obtain chroma and luma components.

In another aspect of the invention, bidirectional combing may be implemented by taking into consideration coarse chroma comparisons between the true pixel GA in the previous frame 311 and the true pixel NA in the next frame 312. The difference between the coarse chroma values for true pixels GA and NA may be indicative of the signal bandwidth between the previous frame 310 and the next frame 312 and whether the composite signal may be combed temporally and to what extent. The bandwidth measure between the true pixels GA and NA and the associated temporal combing quality may then be compared with the quality of 2D combing for the composite signal and whether horizontal and/or vertical combing may be applied within the current frame 304, and to what extent.

If either comparison of coarse chroma or coarse luma difference between true pixels GA and NA indicates a large difference, then it may be indicative of a significant temporal frequency content between the previous frame 311 the next frame 312, and temporal combing, therefore, may not be desirable since it may involve temporal bandwidth losses.

In yet another aspect of the invention, 3D combing may also be implemented taking into consideration temporal signal comparison between adjacent frames for purposes of applying temporal combing with a minimum temporal bandwidth loss. Accordingly, pixels in the same line/previous frame 311 may be considered. For example, true pixel GA may be an actual pixel similar to true pixel A, but it may be phase-shifted 180 degrees from pixel A in the previous frame. True pixel GA may be the same pixel as true pixel A in the previous frame 311, interpolated pixel GAL may be one quarter of a 3.58 MHz subcarrier frequency off to the left in the previous frame 311, and interpolated pixel GAR may be one-quarter of a subcarrier cycle off to the right on the same line in the previous frame 311. Since pixels Ar and GAL may be phase-shifted at 360 degrees and may be in phase with each other, they may be compared for temporal frequency content.

Similarly, pixels AL and GAR may also be compared for temporal frequency content. If these two comparisons indicate that the pixels are similar, then this may indicate that pixel A may be very similar to pixel GA and that there may be no temporal frequency content movement from the previous frame. In this case, temporal combing may be performed since there will be no significant temporal bandwidth loss. If, on the other hand, the two comparisons show a large difference, then it may be indicative of a significant temporal frequency content between the current and the previous frame, and temporal combing, therefore, may not be desirable since it may involve temporal bandwidth loss. A comparison between pixel A and pixel GA may be useful in instance where there may be a pixel that bears no color, for example, a black and/or a white pixel. Such pixels may be characterized only by a luma component and, therefore, have no phase difference between each other. In this case, temporal combing may be applied without any resulting temporal bandwidth loss.

In yet another aspect of the invention, 3D combing may also be implemented by taking into consideration previous motion estimates stored in the QMBF 203 (FIG. 2) made the motion estimator 202 (FIG. 2). These estimates may be used, for example, to aid in the separation of chroma and luma from the video signal 205 (FIG. 2) in areas that may otherwise present a challenge to a traditional comb filter system. For example, it may be difficult to determine which comb method to use for a particular area of the current frame given only the three (3) most recent frames. The QMFB 203 may, however, indicate that motion occurred in that particular area of the display in past frames. With knowledge of the past motion, the system may decide to use horizontal or vertical combing instead of 3D combing. In this regard, the addition of the past motion estimates stored in the QMBF 203 by the motion estimator 202 may improve the ability to separate chroma and luma information from a composite video signal.

A 3D bidirectional comb filter in accordance with an embodiment of the present invention may be implemented by first horizontally combing a composite video signal. The horizontal combing may be accomplished by running the composite video signal through a very wide band pass filter, for example, so that it may pre-filter the very low frequency luma component within the composite video signal. In this way, if there is very coarse (VC), slow moving luma changes, such VC luma may be eliminated and not be considered in subsequent vertical and/or temporal combing processes. If a subcarrier frequency of 3.58 MHz is utilized, chroma components may be centered around 3.58 MHz, or approximately between 2 and 5 MHz. In other words, any frequency content below 2 MHz may be considered a luma component and may be filtered out by the band pass filter. By performing the corresponding comparisons between pixels in the current frame 304, the previous frame 310 and/or the next frame 312, as outlined above, it may be determined whether vertical combing and/or temporal combing may be utilized without significant bandwidth loss. For example, horizontal and vertical combing, or 2D combing, may be the only useful combing methods in one embodiment of the present invention. In another embodiment of the present invention, horizontal, vertical and temporal combing, or 3D combing, may be applied without significant bandwidth loss. The temporal combing may be determined utilizing bidirectional combing between the previous frame 310 and the next frame 312. Temporal combing may also be determined by utilizing combing between the current frame 304 and the previous frame 311. A final combing decision as to a specific composite signal may include a blend of 2D and 3D combing. In this case, a certain percentage of a pixel may be only vertically or horizontally combed, and the remaining pixel may be combed vertically and temporally without utilizing any threshold values.

FIG. 3B is a diagram 330 of a blending decision factor related to blending to a previous line versus blending to a next line, in accordance with an embodiment of the invention Referring now to FIG. 3B, a decision as to the quality of combing with the previous line versus combing with the next line may be accomplished by calculating a ratio k_blend of the previous line compares to the next line compares, for example. The k_blend ratio may be calculated using compares and constant multiplies so that it is a value between zero and one. This may be a non-linear ratio between the comparison to the previous line and the comparison to the next line. A constant value in the k_blend calculation may be utilized to bias strongly against luma only comparisons. In the case of low chroma it may not be desirable to falsely pass the luma only condition. K_blend may be calculated as a function of next_max and prev_max. Next_max may be a measure of the bandwidth difference between a current line and a next line, for example. Prev_max may be a measure of the bandwidth difference between a current line and a previous line, for example. K_blend may be a function of the ratio of prev_max to next_max. The larger the ratio, the smaller the value of k_blend. The previous and next lines may be alpha blended together to comb with the current line. Conceptually the blend tends toward the smaller of prev and next. The blend may skew toward next_line when next_max/prev_max is small, and skew toward prev_line when prev_max/next_max is small.

In one aspect of the invention, a different blending decision factor may be determined. A notch filter may be utilized for horizontal combing. In order to obtain a better combing decision, a notch filter may be compared to a vertical comb filter by calculating a ratio of the quality of the vertical comb using the previous line, to the quality of the horizontal comb. A different ratio may be related to the quality of the vertical comb using the next line, to the quality of the horizontal comb.

FIG. 3C is a diagram 340 of a blending decision factor related to blending vertically versus blending horizontally, in accordance with an embodiment of the invention. Referring now to FIG. 3C, a blending decision factor may be determined from a ratio notch_prev, where notch_prev may indicate whether to blend vertically and/or horizontally between a current line and a previous line. Notch_prev may be determined as a function of prev_line_max and next_pix_max. Prev_line_max may be a measure of the bandwidth difference between a current line and a previous line. Next_pix_max may be a measure of the bandwidth difference between two sets of in-phase pixels in a current line. A higher notch_prev ratio may indicate a preference towards notching versus vertical blending.

A notch_next ratio may be determined in a similar way, where notch_next may indicate whether to blend vertically and/or horizontally between a current line and a next line. A final notch ratio may be determined as a function of the notch_prev and notch_next ratios in order to obtain a blending decision factor related to blending vertically versus blending horizontally. For example, a final notch value for each pixel may be determined by the following equation:

notch=notch_next.*k_blend+notch_prev.*(1−k_blend);

Conceptually, if the k_blend combing decision tends towards combing with the top line, the top line may be given more weight in judging the relative goodness of notching. If the k_blend combing decision tends towards combing with the bottom line, the bottom line may be given more weight in judging the relative goodness of notching.

In cases of significantly more luma than chroma at a given point in a composite signal, a notch filter may be gradually disabled. This may be because the notch filter tends to put most of the signal that may be left, after an initial high pass filter, into chroma. If the combed signal is mostly luma, it may be inefficient to allow it to be put into chroma.

FIG. 3D is a diagram 350 of a blending decision factor related to enabling horizontal combing versus disabling horizontal combing, in accordance with an embodiment of the invention. Referring now to FIG. 3D, a disable notch signal dis_notch_prev may be generated by a ratio of the previous/next line compare with the previous/next line luma only compare. If the point is mostly luma, the luma only compare will be much smaller than the in phase compare. Dis_notch_prev may be determined as a ratio between prev_line_min and same_pix max, for example. Prev_line_min may be associated with a bandwidth difference between in-phase pixels in a current and previous lines. Same_pix_max may be associated with a bandwidth difference between out-of-phase pixels in a current, previous and next line.

Similarly, a dis_notch_next may be determined as a ratio between next_line min and same_pix_max, for example, where next_line_min may be associated with a bandwidth difference between in-phase pixels in a current and next lines. Dis_notch_next and dis_notch_prev, therefore, may be determined by the ratio of the previous or next line luma and chroma compare to the previous or next line luma only compare.

If the amplitude of the band passed video signal is very small relative to the difference to the closest matching adjacent line, then the disable notch parameter may not be an accurate measure. In this case, the disable notch may not be used. A disable vertical notch, dis_vert_notch, parameter may be utilized.

FIG. 3E is a diagram 360 of a blending decision factor related to horizontal combing, in accordance with an embodiment of the invention. Referring now to FIG. 3E, a dis_vert_notch may be calculated as a ratio of notch a abs_filt and min_vert, for example. Notch_a_abs_filt may measure the absolute value of an amplitude of a signal on a current line. Min_vert may be associated with the minimum of bandwidth difference between current line and a previous line, and/or a current line and a next line.

Conceptually, if dis_vert_notch is 0, then it has no effect. Dis_notch may be allowed to mask or not mask notch. If dis_vert_notch is 1, then dis_notch has no effect and dis_notch may be disabled. In this case notch may never be masked, and the decision to notch or vertically comb may be utilized without modification. A weighted disable notch ratio dis_notch may be calculated as:

dis_notch=max(dis_notch, dis_{—}vert_notch)

The calculated notch signal may be cubed and disable notch may be squared. This may cause the roll off due to notch to be accelerated. Then disable notch may be used to calculate a final value for notching. Notch may also be low pass filtered and may be generated according to the following equation:

notch=dis_notcĥ2*notcĥ3

Referring again to FIG. 3A, since true pixels A and GA may be 180 degrees out of phase with each other, in chroma, they may not be directly compared, except in the case where there is no chroma at this point. Points A, B, C and G may be true pixels sampled at 27 MHz. All the other pixels may be interpolated to give 4FSC sample points. Pixels AL and AR may be one quarter of a subcarrier cycle away from true pixel A. Pixels GAL and GAR may be one quarter of a subcarrier cycle away from pixel GA. Since pixels A and GA may be 180 degrees out of phase with each other, AL may be in phase with GAR and AR may be in phase with GAL. Since they may be in phase they can be directly compared. There may be some spatial difference between these pixels and pixels A and GA. But, by shifting the samples a quarter of a cycle in each direction, the spatial difference may be minimized. In order to calculate a measure of temporal bandwidth, in the case where there is no chroma at this point, true pixel G may be compared directly with true pixel A. The actual measure of the temporal bandwidth may be calculated by comparing the temporal bandwidth in the case with chroma and the case of luma only. The results may be low pass filtered.

An estimate may be obtained of the quality of the 2D comb. This may be calculated based on the difference between the current pixel and the pixel that the 2D combing logic decided to comb with. First the vertical difference may be calculated according to the ratio of k_blend. Next this may be blended with the horizontal quality according to the ratio of notch. The qualities of the vertical blends, previous and next, may be weighted together to give an overall vertical quality measure. This vertical quality measure may then be weighted together with the horizontal quality, giving an overall quality measure of the 2D comb.

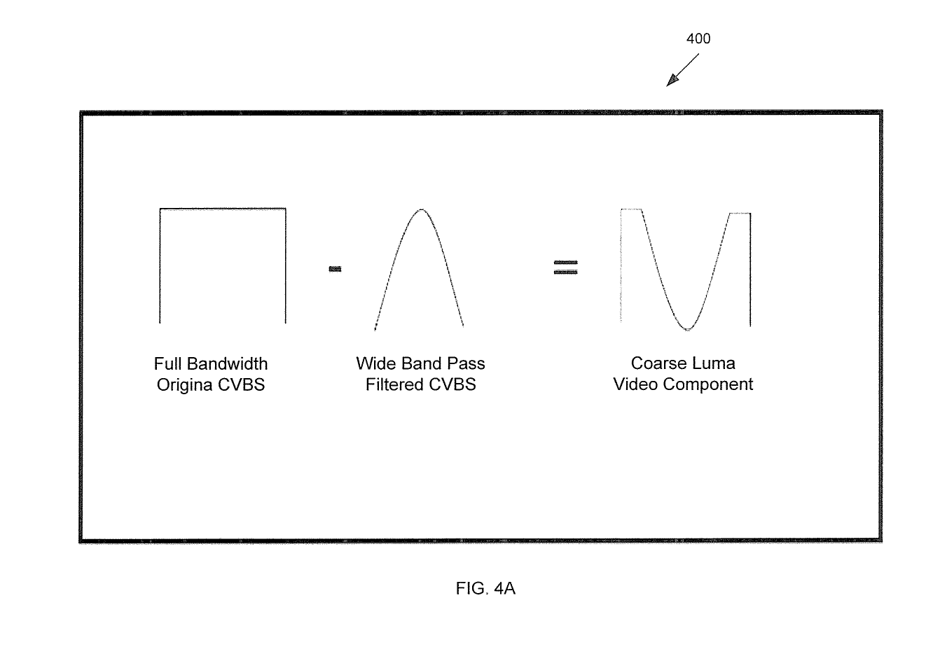

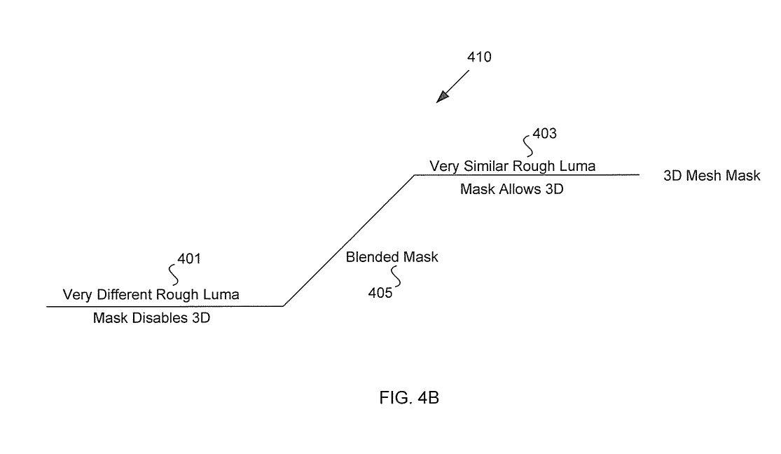

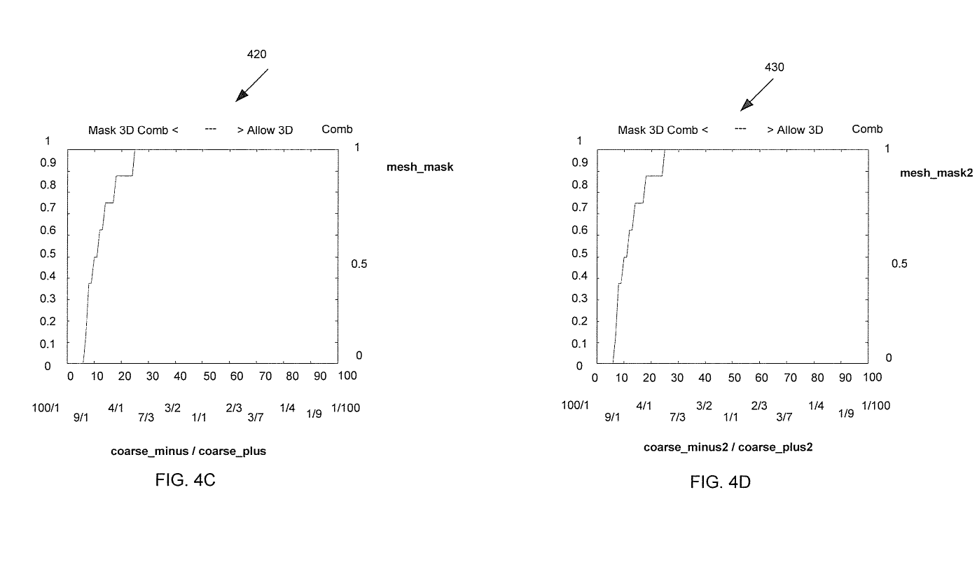

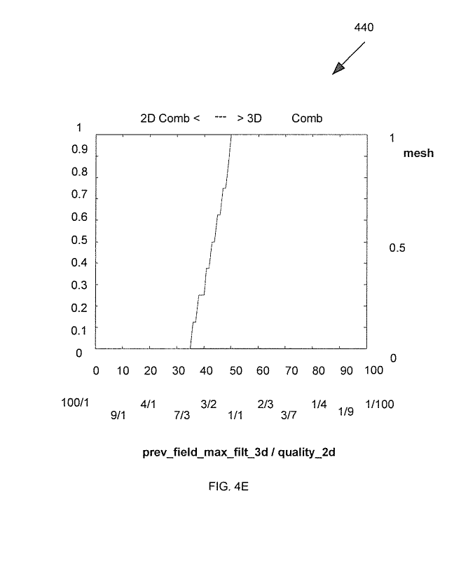

FIG. 4A is a diagram 400 of coarse luma determination, in accordance with an embodiment of the invention. A coarse estimate of luma may be obtained for both the current frame and the previous frame as illustrated in FIG. 4A. This may be accomplished by subtracting the band passed signal from the composite signal. In this way, the part of luma that may be clearly outside the chroma bandwidth range may be obtained. The coarse estimate of luma may be used to mask off the 3D combing decision. If the luma part of the composite signal does not match between the two frames, it may be determined that there may be motion. This may be true even if the band passed part of the signal matches perfectly.

FIG. 4B is a diagram 410 of a 3D comb filter mesh mask, in accordance with an embodiment of the present invention. A mesh mask may be utilized in order to ascertain whether 3D combing may be utilized for a specific composite signal. In a composite video signal, a wide band pass filter may be utilized to filter very high and low chroma and luma components. The output of the wide band pass filter may be subtracted from the original composite signal input, and the low frequency luma component may be obtained, or a rough estimate of the low frequency luma. Such estimate of low frequency luma may be calculated for a current frame and for a previous frame, for example. The two resulting rough values of luma may then be compared on a pixel-by-pixel basis. If the two rough luma values are very different, then 3D combing may be disabled by the mask, at 401, and 2D combing may be the only method that may be applied to separate luma and chroma components in the composite video signal. If the two rough luma values are very similar, then 3D combing may be allowed by the mesh mask, at 403, and the composite video signal may be combed horizontally, vertically and temporally. For any value of the luma difference, which may be between 401 and 403, a blended mask 405 may be applied to separate the luma and chroma components of the composite video signal.

In another aspect of the invention, bidirectional combing may be applied and estimates of low frequency luma may be calculated for a previous frame and a next frame, for example. The two resulting rough values of luma may then be compared on a pixel-by-pixel basis. The same 3D mesh mask as illustrated on FIG. 4B may be utilized in the case where bidirectional combing may be used to determine applicability of temporal, or 3D, combing. If the two rough luma values are very different, then 3D combing may be disabled by the mask, at 401, and 2D combing may be the only method that may be applied to separate luma and chroma components in the composite video signal. If the two rough luma values are very similar, then 3D combing may be allowed by the mesh mask, at 403, and the composite video signal may be combed horizontally, vertically and temporally. For any value of the luma difference, which may be between 401 and 403, a blended mask 405 may be applied to separate the luma and chroma components of the composite video signal.

In yet another aspect of the invention, the blended mask 405 may be applied in cases where the two rough luma values may not be very different. A blended mask may indicate, for example, that a certain percentage of the 3D combing, for example 30%, may be “trusted” and the remaining percent, for example the remaining 70%, may be combed via 2D combing. The blended mask may re-adjust the ratio between 3D combing and 2D combing for a given pixel depending on how close the two rough luma values are to being very different and how close they are to being very similar.

FIG. 4C is another diagram 420 of a 3D comb filter mesh mask, in accordance with an embodiment of the invention. Mesh_mask may be determined as a ratio between coarse_minus and coarse_plus, for example. Coarse_minus may be the difference between lumas of previous and current frames. Coarse_plus may be the sum of lumas of previous and current frames. Mesh_mask ratio may tend towards masking 3D combing if the luma between the two consecutive frames is very different. It may also tend towards allowing 3D combing if the luma between the two consecutive frames is very similar.

FIG. 4D is a diagram 430 of a 3D comb filter mesh mask for bidirectional comb, in accordance with an embodiment of the invention. Mesh_mask2 may be determined as a ratio between coarse_minus2 and coarse_plus2, for example. Coarse_minus2 may be the difference between lumas of previous and next frames, as may be determined according to bidirectional combing methods described above. Coarse_plus2 may be the sum of lumas of previous and next frames. Mesh_mask2 ratio may tend towards masking 3D bidirectional combing if the luma between the previous and next frames is very different. It may also tend towards allowing 3D bidirectional combing if the luma between the two consecutive frames is very similar.

FIG. 4E is another diagram 440 of a 3D comb filter mesh, in accordance with an embodiment of the invention. Referring now to FIG. 4E, a mesh ratio may be determined as a measure of combing quality of 2D combing versus 3D combing. Mesh ratio may be determined as a ratio between prev_field_max_filt_3d and quality_2d. Prev_field_max_filt_3d may be a measure of bandwidth difference between a pixel in a current frame and the same pixel in a previous frame. Quality_2d may be a measure of quality of 2D combing, as measured, for example, by various ratios as specified above in this application.

To determine the blending of 3D combing versus 2D combing the quality of the 2D comb decision may be compared with the quality of 3D combing. The ratio of these two numbers determines the blend between 2D and 3D combing. Conceptually, mesh may tend towards the smaller of quality_2d (error term of 2D comb) and prev_field_max_filt_3d (error term of 3D comb). The larger prev_field_max_filt_3d may be (or the worse the quality of the 3D comb), the more mesh may tend to 2D comb. The larger quality_2d (or the worse the quality of the 2D comb), the more mesh may tend to 3D comb.

A final blend of 3D combing and 2D combing may be based on the product of the mesh and the mesh mask. The following equation may be utilized:

mesh=mesh*mesh_mask

### The final mesh value may be used to alpha blend the chroma and luma between 2D and 3D combing.

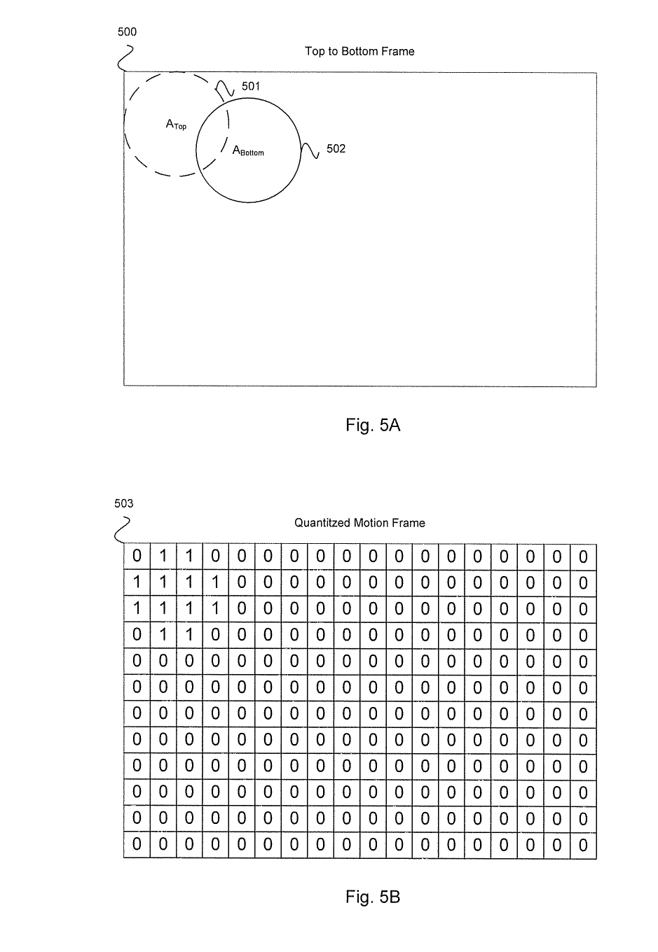

FIG. 5A is a figure representing motion between a top frame and a bottom frame, in accordance with an embodiment of the invention. Referring to FIG. 5A, there is shown a frame 500, a region corresponding to a top video frame 501, and a region corresponding to a bottom video frame 502. The region corresponding to the top video frame 501 may have moved to a new region in the bottom video frame 502.

FIG. 5B is a figure of an exemplary quantized motion frame buffer (QMFB) in accordance with an embodiment of the invention. Referring to FIG. 5B, there is shown a frame comprised of motion estimates 503. The motion estimator 202 (FIG. 2) may compare on a pixel by pixel basis the pixels in the top and bottom frame by computing the difference between the pixel values and comparing that difference to a threshold. If the difference, for example, is greater than a threshold, the motion estimator may store a one (1) in the area of the QMFB 203 (FIG. 2) corresponding to the area where the difference was detected. Where the difference is less than the threshold, the motion estimator may store a zero in the area of the QMF buffer 203 (FIG. 2) corresponding to the area where no difference was detected.

The data stored in the QMFB may be considered a motion estimate of the motion detected in, for example, the current frame in the frame buffer. This data may then be applied to subsequent frames and may aid in the separation of chroma and luma information from those frames. In this regard, the more motion estimates that may be available, the more accurately future motion may be detected by the comb. This may result in more accurate chroma/luma separation.

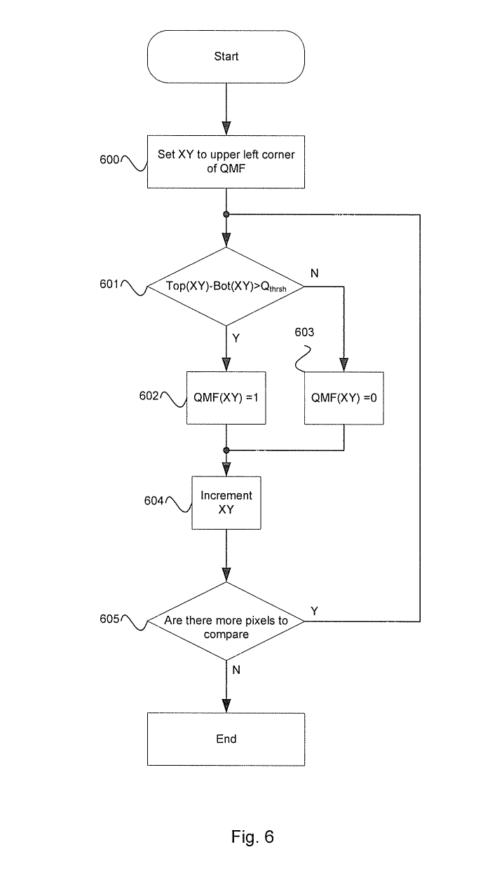

FIG. 6 is a flow diagram that of an exemplary motion estimator for 3D bidirectional combing, in accordance with an embodiment of the invention. Referring to FIG. 6, at step 600, the motion estimator 202 (FIG. 2) may initialize variable X and Y. These variables in combination may be used to locate a particular pixel in a frame. For example, the upper left corner of a frame may correspond to an X and Y value of zero (0). Variables X and Y may be used as indices for two looping procedures. For example, the index X may be used to loop horizontally through a frame and index Y may be used to loop vertically through a frame.

At step, 601, the difference between a pixel at index X and Y of the Top frame and index X and Y of the bottom frame may be computed. If the difference is greater than a quantization threshold, then at step 602 the motion estimator 202 may write a one (1) at location (X,Y) in the quantization frame buffer 203 (FIG. 2). If the difference is less than the quantization threshold, then at step 603 the motion estimator 202 may write a zero (0) at location (X,Y) in the quantization frame buffer 203. In this regard, memory efficiency may be dramatically improved by writing a single bit to the QMFB rather than storing additional past frames in memory for the purpose of determining motion in past frames.

At step 604, indices X and Y may be incremented in such a manner that all the pixels in the top frame and bottom frame may be compared. At step 605, it may be determined whether there are more pixels to process. If there are more pixels to process, the next step is step 601. If there are no more pixels to be processed, the process may end.

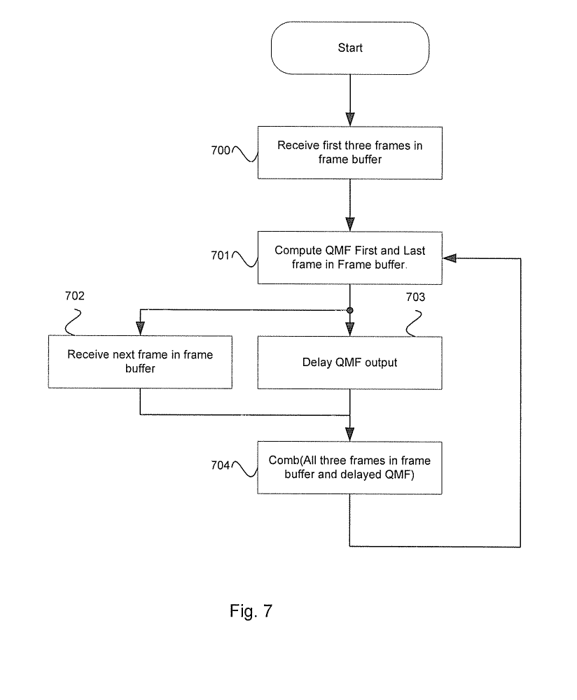

FIG. 7 is a flow diagram of exemplary steps utilizing past motion estimates in a 3D bidirectional combing system, in accordance with an embodiment of the invention. Referring to FIG. 7, the frame buffer 201 may be initially empty. In step 700, the first three frames of video information may be read and stored into the frame buffer 201. The three frames of video information may occupy the portions of the frame buffer 201 corresponding to the top, current, and bottom frames.

At step 701, the motion between the top and bottom frames may be detected using the motion estimator 202. For example, the motion estimator 202, via the process described above, may compare the difference between the two frames to a threshold to derive motion estimates for the current frame. The motion estimates may then be stored to the QMFB 203.

Steps 702 and 703 may occur simultaneously. At step 702, a new frame may be received by the frame buffer 201, while at step 703, the motion estimates in the QMFB 203 may be shifted by one frame. At step 704, the current frame may be combed using the top, current, bottom frames as well as the motion estimates stored in the QMFB 203 delayed by one (1) frame. These steps may be illustrated in Table 1. Referring to Table 1, shown are the frames of data applied to the combing process as a function of time. At time t1, frame F2 may be combed by using frames F1, F2, and F3, which may correspond to the top, current and bottom frames respectively, and the motion estimates corresponding to frame F1. At time t2, frame F3 may be combed by using frames F2, F3, and F4, which may correspond to the top, current and bottom frames respectively, and the motion estimates from frame F2. The result of this may be that motion estimates for previous frames may be utilized to separate chroma and luma information in the combing process at step 704. The availability of the motion estimate for the old frames may aid the comb in separating the chroma and luma information.

TABLE 1

| | t₁ | t₂ | t₃ |
|---|---|---|---|
| Top | F1 | F2 | F3 |
| Current | F2 | F3 | F4 |
| Bottom | F3 | F4 | F5 |
| Delayed QMBF | QMBF (F1) | QMBF (F2) | QMBF (F3) |

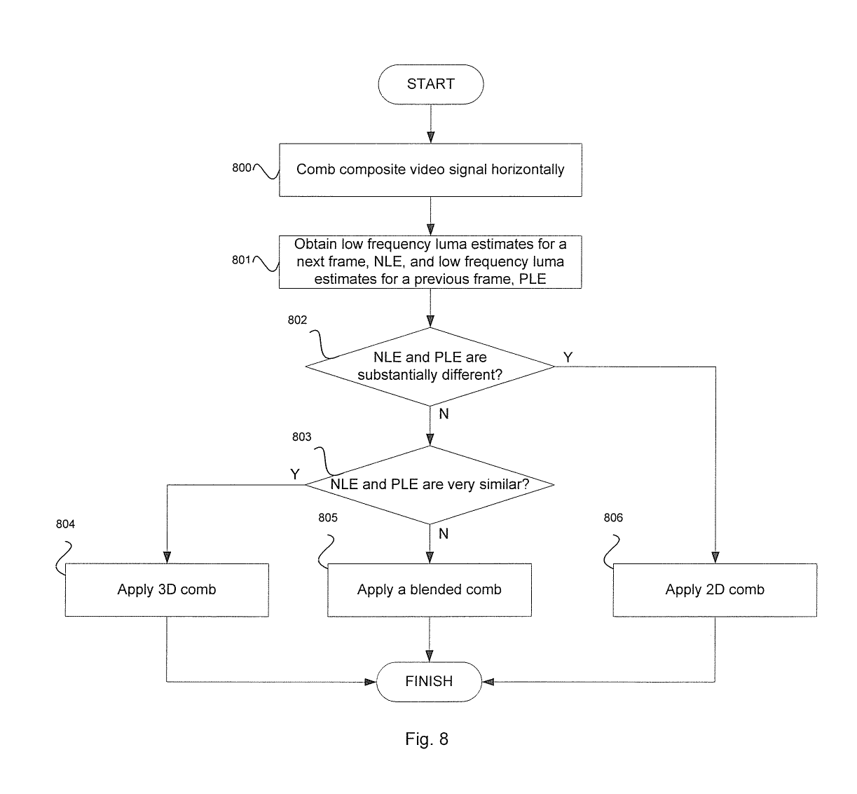

FIG. 8 is a flow diagram of an exemplary method for bidirectional comb filtering of a composite video signal, in accordance with an embodiment of the invention. At 800, a composite video signal may be combed horizontally. For example, a composite video signal may be notch filtered by utilizing a wide band pass filter. At 801, estimates of a low frequency luma component for a next frame, NLE, and a low frequency luma component for a previous frame, PLE, may be obtained. For example, in order to estimate NLE and PLE, the output of the wide band pass filter may be subtracted from the original composite video signal. At 802, it may be determined whether NLE and PLE may be substantially different. If NLE and PLE are substantially different, at 806, 3D bidirectional combing may be disabled and only 2D combing may be utilized with the original composite video signal. If the NLE and PLE are not substantially different, at 803, it may be determined whether NLE and PLE may be very similar. If NLE and PLE are very similar, at 804, 3D bidirectional combing may be applied to the original composite video signal. If NLE and PLE are not very similar, a blended comb approach may be taken, at 805. In this way, a certain percentage of vertical and bidirectional temporal combing may be utilized with the original composite video signal.

In operation, the comb filter 200 (FIG. 2), may be adapted to receive a video signal 205 (FIG. 2), separate the chroma and luma components, and then output the chroma component and the luma component separately. The processor 206 (FIG. 2) may generate a plurality of interpolated pixels in a previous frame, which corresponds to the interpolated pixels in the current frame. The processor 206 may generate a plurality of interpolated pixels in a next frame, which corresponds to the interpolated pixels in the current frame. The processor 206 may determine at least one direction of least bandwidth among at least a portion of all the generated interpolated pixels and true pixels in the current frame, and may blend combing according to the determined at least one direction of least bandwidth.

The interpolated pixels generated by the processor 206 for the current frame may be one half cycle phase-shifted from the interpolated pixels in the previous frame and or in the next frame. The interpolated pixels generated by the processor 206 for the previous frame may be in-phase with the interpolated pixels in the next frame. The processor 206 may generate the plurality of interpolated pixels for the current line, so that each of the plurality of interpolated pixels in the current line may be one quarter cycle phase-shifted from a corresponding adjacent pixel in the current line. The processor 206 may be adapted to comb horizontally, if the determined direction of least bandwidth may be among in-phase interpolated pixels in the current line. The processor 206 may comb vertically, if the determined direction of least bandwidth is, for example, among corresponding in-phase interpolated pixels in the current line and at least one of the previous line and the next line.

The processor 206 may comb vertically, if the determined direction of least bandwidth is, for example, among corresponding one-half cycle phase-shifted true pixels in the current line and at least one of the previous line and the next line for a luma-only video signal. If the determined direction of least bandwidth is among corresponding in-phase interpolated pixels in the previous frame and in the next frame, the processor 206 may comb temporally. If the determined direction of least bandwidth is among corresponding in-phase true pixels in the previous frame and in the next frame, the processor 605 may comb temporally. The processor 206 may comb in a horizontal direction and a vertical direction for the current video frame, and may blend the combing in the horizontal direction and the vertical direction and combing in a temporal direction for the current video frame. In this regard, previous motion estimates stored in the QMBF 203 (FIG. 2) may be taken taking into consideration. With knowledge of the past motion, the system may decide to use one combing method over another. The addition of the past motion estimates stored in the QMBF 203 by the motion estimator 202 (FIG. 2) may improve the combing systems ability to separate chroma and luma information from a composite video signal. Furthermore by writing a single bit to the QMFB 203, as opposed to multiple frames from the past, memory use may be optimized.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments failing within the scope of the appended claims.

What is claimed is:

1. A method for processing signals in a video system, the method comprising: comb filtering a current video frame based on motion estimates derived from previously processed video frames.

2. The method according to claim 1, comprising detecting motion in at least one of a plurality of said previously processed video frames.

3. The method according to claim 2, comprising storing a result of said detection of motion for said plurality of previously processed video frames in a buffer.

4. The method according to claim 3, comprising storing said result of said detection of motion in a location in said buffer, which corresponds to a location where said motion was detected in said current frame video frame.

5. The method according to claim 1, comprising computing a difference between at least two of said previously processed video frames on a pixel by pixel basis.

6. The method according to claim 1, comprising computing a difference between a top and bottom video frame on a pixel by pixel basis.

7. The method according to claim 5, comprising comparing said difference to a threshold.

8. The method according to claim 1, comprising extracting chroma and luma information from said current video frame.

9. A machine-readable storage having stored thereon, a computer program having at least one code section for processing signals in a video system, the at least one code section being executable by a machine for causing the machine to perform steps comprising: comb filtering a current video frame based on motion estimates derived from previously processed video frames.

10. The machine-readable storage according to claim 9, comprising code that enables detecting motion in at least one of a plurality of said previously processed video frames.

11. The machine-readable storage according to claim 10, comprising code that enables storing a result of said detection of motion for said plurality of previously processed video frames in a buffer.

12. The machine-readable storage according to claim 11, comprising code that enables storing said result of said detection of motion in a location in said buffer, which corresponds to a location where said motion was detected in said current frame video frame.

13. The machine-readable storage according to claim 9, comprising code that enables computing a difference between at least two of said previously processed video frames on a pixel by pixel basis.

14. The machine-readable storage according to claim 9, comprising code that enables computing a difference between a top and bottom video frame on a pixel by pixel basis.

15. The machine-readable storage according to claim 13, comprising code that enables comparing said difference to a threshold.

16. The machine-readable storage according to claim 9, comprising code that enables extracting chroma and luma information from said current video frame.

17. A system for processing signals in a video system, the system comprising: circuitry that enables comb filtering of a current video frame based on motion estimates derived from previously processed video frames.

18. The system according to claim 17, comprising circuitry that enables detecting motion in at least one of a plurality of said previously processed video frames.

19. The system according to claim 18, comprising circuitry that enables storing a result of said detection of motion for said plurality of previously processed video frames in a buffer.

20. The system according to claim 19, comprising circuitry that enables storing said result of said detection of motion in a location in said buffer, which corresponds to a location where said motion was detected in said current frame video frame.

21. The system according to claim 17, comprising circuitry that enables computing a difference between at least two of said previously processed video frames on a pixel by pixel basis.

22. The system according to claim 17, comprising circuitry that enables computing a difference between a top and bottom video frame on a pixel by pixel basis.

23. The system according to claim 21, comprising circuitry that enables comparing said difference to a threshold.

24. The system according to claim 17, comprising circuitry that enables extracting chroma and luma information from said current video frame.
